(19) United States
(12) Patent Application Publication
(10) Pub. No.: US 2010/0241944 A1
(43) Pub. Date: Sep. 23, 2010

(54) METHOD AND APPARATUS FOR ASSOCIATING ADVERTISING CONTENT WITH COMPUTER ENABLED MAPS

(75) Inventors: Athellina Athsani, San Jose, CA (US); Marc E. Davis, San Francisco, CA (US); Christopher W. Higgins, Portland, OR (US); Christopher T. Paretti, San Francisco, CA (US)

Correspondence Address: YAHOO!, 701 FIRST AVENUE, SUNNYVALE, CA, 94089, US

(73) Assignee: YAHOO! INC., Sunnyvale, CA (US)

(21) Appl. No.: 12/407,681

(22) Filed: Mar. 19, 2009

(51) Int. Cl. G06Q 30/00; G06F 17/30; G06F 17/00; G06Q 20/00

(52) U.S. Cl. 715/230; 705/40; 705/10; 715/764; 707/E17.014; 705/14.53; 705/14.57

(57) ABSTRACT

A computer based system and method for mobile and online Internet type advertising that includes advertisements in “tag maps”, which are interactive maps with associated text strings. The system allows advertisers to buy, lease or bid in real time for advertising opportunities associated with particular tags (text strings) within such tag maps. This is in the context of Internet web pages. This further allows advertisers to modify the display or content of the associated tag maps and/or advertising units.

### FIELD OF THE INVENTION

This disclosure relates to the Internet and Internet communications and specifically to Internet distributed maps which are also interactive.

### BACKGROUND

U.S. patent publication US 2008/0148175A1, published Jun. 19, 2008, first named inventor Mor NAAMAN, incorporated herein by reference in its entirety, discloses what is referred to as “tag maps” technology. Briefly, this visualizes datasets by associating text (keywords) with geolocations on a displayed computer map and optionally with time. The visualization is intended to help the computer user better understand and analyze the contents of the dataset. The visualization takes as input a keyword and related parameters such as location, importance/relevance factors, time, visualization level, and keyword category and displays on the user's computer screen the selected keywords on a map with their associated location with the size or other characteristic of the keyword shown according to its relevance to some metric such as popularity. This is in the context of the Internet where the map database is maintained at a server and a user accesses this via the Internet via a client (software) such as a web browser at his computer remotely. In this case, FIG. 1 shows an outline map of the city of San Francisco and part of San Francisco bay with superimposed on the map a dataset of SMS messages originating or associated with the San Francisco, Calif. location and showing three movie titles sized according to their popularity. Note that these keywords are not intrinsically linked to a particular geographic location or feature on the map, but merely happen to be movies being presented somewhere in San Francisco. In this case, the details of the map have been suppressed in terms of actual geographical details, but these may be displayed also.

FIG. 2, taken from the same patent application document, shows a system in accordance with that document for providing the so-called tag maps. The tag is a reference to the text shown in FIG. 1, also known as keywords or a dataset or text string. User 1 at a personal computer 2 executing a conventional web browser 4 and optionally a client-side visualization application (not required) may access a website over the Internet or other network 6 being hosted on a main server 8. Main server 8 may be executing a visualization algorithm 20 to perform visualization at the website. Alternatively, the main server 8 may be in communication with a second server 10 over a private network or the Internet wherein the visualization algorithm 20 is performed at the second server and the results are sent back to the main server 8.

A storage device or memory 12 may store one or more datasets such as a dataset of photos, SMS messages such as in FIG. 1, search terms and the like. A context server 14 may operate on one or more datasets 22 to generate visualization data 16 comprised of keywords or labels and other values associated with each label such as latitude, longitude, a time or time range for which the information is valid, and one or more associated relevance values. Note that servers 8 and 14 may be combined into one server. The user may use a client-side software application (computer program) to request that certain visualization data be visualized using a particular visualization scheme and they also request a particular map area. Main server 8 or second server 10 then performs a visualization algorithm on the visualization data 16 and maps data from the map server 18. The map server 18 produces conventional interactive computer-type map information in accordance with the geographical request from the user 1. While the map server shown in FIG. 2 is a separate server, it may be the same server as the main server 8 or the second server 10 or the context server 14. The main server 8 or second server 10 then produces rendering information and transmits it to the personal computer 2 so that it can be rendered by the web browser 4 or used by the user.

### SUMMARY

The present disclosure is directed to improvements over the above described tag maps by including advertising content therein. Note that these advertisements are not the same as the mere text messages shown in FIG. 1, but include actual advertisements which may be in themselves interactive and are typically more than mere text strings. Typically they may be interactive and include images or video or audio as conventional for Internet advertising. Hence the present system and method allow advertising in combination with such available maps to personalize targeting of an advertisement to a particular user and to provide an interactive user experience related to the advertiser or advertisement or offer, but which is generated from a repurposing of user attention. The advertising content is meant to increase user attention and advertising effectiveness for both brand and direct marketing advertising. The advertisements are matched to the user by selecting a particular advertisement using a relevant measurement to a map location indicated by the user.

This is intended to overcome the typical Internet advertising situation where advertising is not personalized, that is it is displayed to all users and hence is little of interest to most users. It has been found that consumers who view advertising increasingly expect advertising content that is associated with the particular map location when they are searching for stores, restaurants, products, entertainment, etc. It has been found that such targeted ad content increases sales for specific products and services and so is of more value to advertisers.

### BRIEF DESCRIPTION OF THE DRAWINGS

FIG. 1 shows in the prior art a map with keyword text displayed thereon.

FIG. 2 shows in the prior art a system for accomplishing the map displayed in FIG. 1.

FIG. 3 shows a flow chart of activity in accordance with the present invention.

FIG. 4 shows a system for carrying out the process of FIG. 3.

FIGS. 5 and 6 show screenshots of tag maps with advertising in accordance with the present invention.

FIG. 7 shows a prior art computer system suitable for servers and computers used in accordance with the present method.

### DETAILED DESCRIPTION

This application relates to commonly assigned U.S. patent application Ser. No. ______, filed ______, inventors Marc E. DAVIS, Christopher W. HIGGINS, Christopher T. PARETTI, and Athellina ATHSANI, entitled METHOD AND APPARATUS FOR ASSOCIATING ADVERTISING WITH COMPUTER ENABLED MAPS, referencing Attorney Docket No. 324212025700. It has been determined by the present inventors that Internet users tend to ignore traditional Internet advertising (referred to as banner or line listing advertisements), which are the kind of ordinary advertisements included in web pages and typically lack any element of personalization. It has also been found that interactive software applications provided separate from advertising comment fail to increase interaction rates with advertising by users. It is known to use personalized software applications which provides advertisements which are only personalized at the initial display of a particular web page. However, this type of user targeting is not particularly refined or sophisticated and does not use any type of real time user interaction, unlike that in accordance with the present invention.

Hence the present approach provides an approach referred to here as “tag maps content matching”, which matches an advertiser (not necessarily a commercial entity) who is provided various advertising copy or advertising opportunities with a particular interactive computer-based map display and which also matches the advertising with a user's exploration within a map, such as a tag map as described above. This includes allowing an advertiser to buy, lease or bid in real time for associating his ads with specific keywords, e.g., text strings or tags in the tag map approach or groups of tags and/or geolocations, that is map locations. This is based on a qualified or intelligent match between the advertiser or his tags or geolocations and the user, employing an approach which analyzes the “who, what, when and where” (“4Ws”) of both the advertiser and user. This is what is referred to as being a qualified match.

Therefore instead of a more naive keyword descriptive matching of an advertiser to a tag, this 4W matching approach enables matching of the advertiser or his advertising copy to the tag or text string or location within the tag map based on a relevance of the advertisement, that is advertising copy to the tag based on the above 4W (who, what, when and where) data.

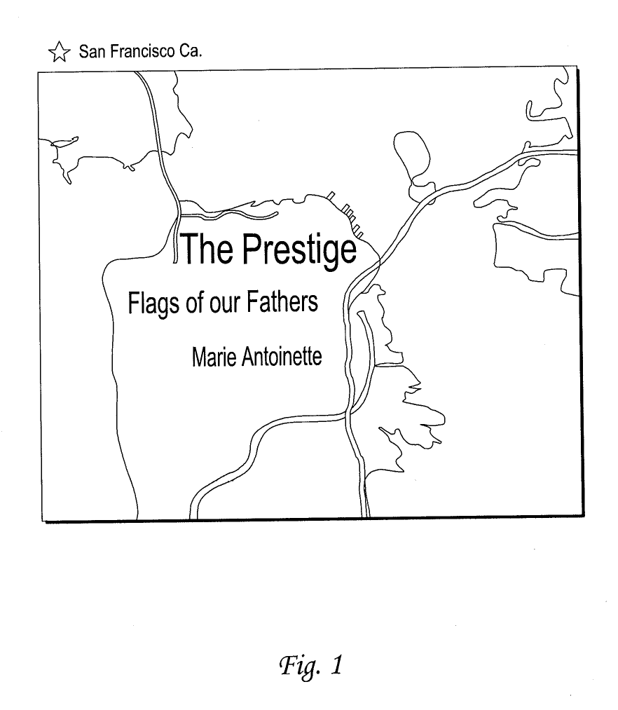

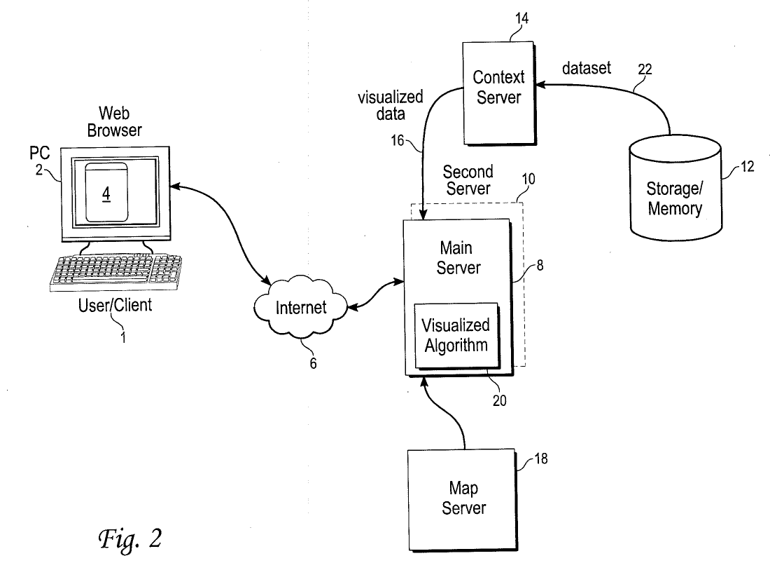

As an example with reference to FIG. 1 assume that an owner of a particular restaurant located in a particular location in San Francisco, Calif., wishes to bid on the most popular keywords for a tag map of the Presidio (a park area in the city of San Francisco). The Presidio is on the ocean and includes a beach area and has on its grounds a statue of the film character Yoda. Thus the owner of the restaurant could bid on keywords for the tag map of the Presidio portion of San Francisco, which include the tags “great beach” and “Yoda statue”. The owner of the restaurant then has 4W relevance to those tags within that particular map. Of course that particular restaurant owner may be bidding against other nearby restaurants, shops or other advertising entities. He could also designate keywords such as “restaurant” or the particular type of food he serves such as “pizza” as additional matching words.

In one embodiment, the relevance of a particular advertisement or advertisement to tags, terms or locations is further modified by the price that a particular advertiser is willing to pay to the operator of the system. Other modifications may be pertinent to the terms of the “lease” (temporary use) of the tags or the highest advertiser bid and the existence of other or more relevant advertisements from other advertisers. This allows higher paying advertisers to capture and keep larger geographic or tag related territories within a particular tag map, based on the willingness of a particular advertiser to pay for advertising opportunities. An advertiser can also pay for more marginal relevance (lower 4W) scores, that is he may bid for tags which are not actually relevant to him, but which he think might generate business.

In one embodiment, the higher the relevance to a specific term of a specific advertiser the more likely that advertiser will be willing to bid for an exclusive or longer term arrangement with the system operator for that tag or territory within a specific tag map. For example, Disney Corporation may pay for exclusive rights to many, but not all, tags within a tag map of the Disney World park in Florida. At the same time, Disney Corporation would be willing to also set up an arrangement for clickthrough advertising for selling DVDs of movies of Disney characters associated with particular rides in Disney World included within the interactive tag map.

Because particular tags within a tag map are a set of terms (text strings) associated with a particular map location (geolocation) and some form of content by users, the number and type of tags is unlimited and may change over time based on language or user preferences. There is also the possibility of providing an auto-tagging device and processes. Therefore, one advertiser typically would not own all associated tag terms which relate to his business, and if a publicly used term becomes associated with a particular advertiser then that tag or term within the context of a tag map would be a new item for other advertisers or the same advertiser, but again would generate further revenue for the system operator. For example, a tag map of Hollywood, Calif., might include tags associated with the Scientology sect, including tags associated with their legal issues or critics that might include links to anti-Scientology groups or information.

In one embodiment, a particular advertiser selects the parameters, tags and terms for his advertising program. Parameters can include advertising bidding types where the advertiser bids on ads based on the target user's 4W conditions. For instance, if the user is on a mobile device vs. a laptop computer, the user's current location (if the user is viewing the tags in the same vicinity as the map location, there is a high chance that the user is looking for entities within a certain radius of the vicinity), current activity (if the user is out with friends, the user may be more interested in ads that accommodate groups), current timeframe (if the user is browsing during lunchtime, the user maybe interested in meal ads). Registration and association of the ad copy and terms may be performed automatically by particular software applications of the type used in the field. See for example co-pending and commonly owned U.S. patent application Ser. No. 11/560,320, filed Nov. 15, 2006, Ronald Martinez, et al. and U.S. Ser. No. 11/770,134, filed Jun. 28, 2007, Christopher W. Higgins et al., both incorporated by reference in their entireties. For example, existing display advertising content could be modified for display within tag maps and the CPM (cost per thousand) or CPC (cost per mouse click) associated with that particular advertising content could be replicated within the present content matching process for inclusion and adoption of advertisers and content.

As indicated above, the relevance of an advertiser to a particular tag is a precursor for any association of the advertiser with that tag. In one embodiment, the possibility of an advertiser buying, leasing or bidding for a particular tag is provided along a sliding scale of relevancy from low relevant to highly relevant. For instance, a trademark, which may only be associated with one particular advertiser and not leased or bid for others without proper permission or fair use, would be highly relevant. A buyer may generally obtain exclusive use of a tag or term based on a time limited relevancy, that is “lease” that tag or term. This is useful if the term is for a particular event or meeting and hence the buyer's interest in that term expires at a particular time. Other terms are typically bid upon by many advertisers based on their 4W relevancy to actual real time tag map request. Other criteria are the maximum bid by a particular advertiser and other data pertaining to the advertiser of interest to the system operator, such as his total advertising budget or some preferred status with the system operator.

The system operator thereby effectively maximizes revenues generated by use of the present system. “System operator” here generally refers to the entity operating the system described here. This may in fact be more than one entity and in some cases an advertiser may operate his own system. The present system operates in the context of websites such as Google, Yahoo!, etc., which attract a large numbers of people to which advertisers wish to obtain exposure.

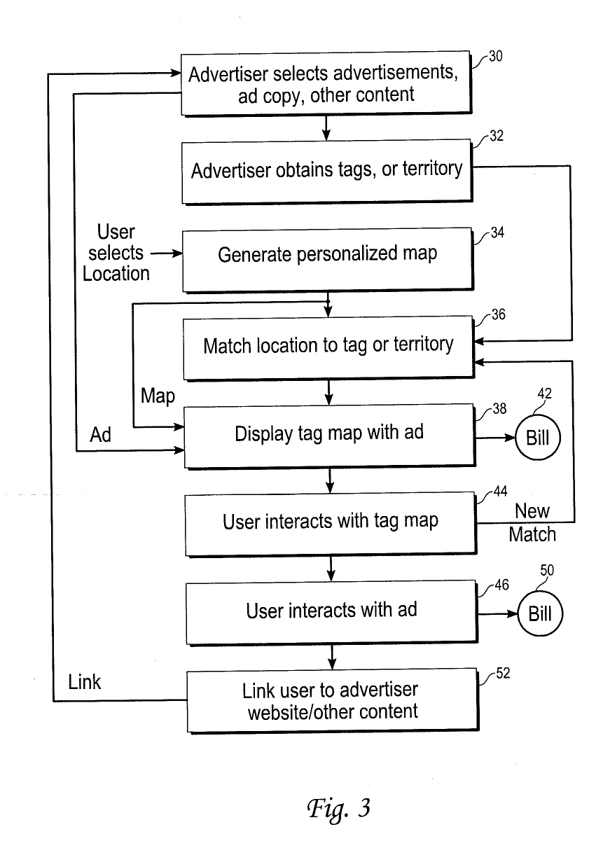

FIG. 3 shows in flow chart a process in accordance with the present invention for matching tag maps with advertising. This process is typically carried out by computer software executed on computers or computer servers, as explained in further detail below.

In the first step 30, carried out before the rest of the steps in FIG. 3 and not necessarily immediately before, an advertiser creates or selects his advertisements or portions thereof (“advertising copy”) , or other content which he wishes to present to users and stores this in a database or similar information system typically on a computer readable memory. This process may be supported by his marketing or other website which also performs other web related functions.

Next in step 32, the same advertiser selects or is assigned particular tags relating to a particular tag map or set of maps maintained by a website system operator, typically a separate entity. He may do this by browsing through a database provided by the system operator of all the tag maps with their associated tags. At any one time a number of the tags may already be under control of another advertiser and hence not available. The system operator maintains a current database of available tags for availability to advertisers. The advertiser may of course also select a particular territory, such as the city of San Francisco or the Presidio neighborhood of San Francisco as pointed out above, rather than mere tags. The advertiser at this time sets terms with the system operator to pay for whatever he obtains in step 32, as indicated further below in terms of the payment mechanism. Payment need not be made at step 32, but in other embodiments it is.

Next in step 34 in response to a user request (the user is a consumer or other advertising target), the system operator (who maintains the tag maps) generates in response a personal tag map for that particular user, the map being modified for the user's context and his display medium such as a desktop computer, laptop computer, mobile telephone, etc., and the system operator passes that personalized map to the matching function in step 36. “Context” refers to the user's 4W conditions, i.e. where he is currently, what device/computer he is using to view the map, what time/season it is, how frequently he is viewing the same thing, what language he prefers, what sort of tags he is affiliated to or partial to. Typically the personalized map in step 34 is generated by a software entity (module) referred to here as a tag maps manager.

Then in step 36, the matching function (carried out by another software entity referred to here as a tag map content manager engine) matches the advertiser and/or his specific advertising copy or advertising campaign to tags in the tag map of step 34 and alters the tag map display to embed advertising content and software instrumentation conditionals. For example, the tag map manager engine may customize the ad or map display based on the user's device limitations or specifications. For instance, this is done to display an advertisement that is more appropriate for a mobile device screen, or provide audio ads vs. an ad display when the engine knows the user is driving a vehicle while surfing the web on a mobile device. The resulting altered tag map is then transmitted to the user's display device, typically via the Internet. Thereby in step 38 the user sees a display of the tag map with the particular ad as pulled from the advertising database generated in step 30. Typically this display of the tag map is considered a billable event to the advertiser at step 42. In other words, the advertiser has to pay the system operator for this activity under the terms agreed to beforehand when he obtained his tags or territory in step 32.

Next in step 44, the user conventionally interacts with his displayed tag map, including the advertising, for instance by mouse clicking on or otherwise selecting (depending on his computing platform) various portions thereof including (hopefully) the advertisement itself. This user exploration of the tag map modifies the displayed ads typically and may trigger a new request for a new tag match which is then transmitted back up to step 36 in iterative fashion. Thereby one can trigger a new matching of advertising content to map tags based on real time interaction events by the user. In step 46, the user interacts with the actual advertisement. This interaction with the advertisement is also a billable event to the advertiser in step 50. The terms of event 50 of course may differ from those for the billable event of step 42, depending on the sophistication of the contract between the advertiser and system operator.

Finally in step 52, the user by mouse clicking on or otherwise selecting the ad copy is re-directed to the advertising website or other content under control of the advertiser as indicated by the return to step 30 from step 52.

In the above process in various embodiments there may be other modifications. For instance, when the tag map manager generates the tag map in step 34, this process may take into account aspects of the specific requesting user including for instance his/her associated user profile or other user data conventionally stored by the system operator or sensor. In one embodiment, a “4W community” is established that is a collection of users, devices and processes that foster both synchronous and asynchronous communications between users and their proxies, providing an instrumented network of sensors providing data recognition and collection in real-world environments about any subject, location, user or combination thereof, or other user context data.

This map generation may also be dependent on the specific display medium of the user. For instance, if he is using a small screen mobile telephone as a computing device, the ad content delivered to the user may be different than if he is using a full featured laptop computer screen. Hence the tag map delivered to the user may be personalized based on specific user criteria or customized based on other aspects depending on user context. However the tag map is generally generic or anonymous as to a specific user. That is a user's identity is normally not communicated back to the advertiser, so as to preserve his confidentiality.

The matching function carried out in step 36 may be based upon either explicit instructions, that is terms set by the advertiser, or in some embodiments upon a more automated software based “4W” analysis of the advertiser, the particular advertising copy, and associated known content related to the advertiser or associated user profile and data analysis logic. In some embodiments, the actual advertising copy is chosen for each and every tag within a tag map, and all the tags and associated content are embedded in instructions delivered to the user's display (computing) device. In these embodiments, all of the content may operate independently once it is delivered to the client thereby generating further billable events from the client (client refers to the web browser or equivalent user interface software which supports web access operating on the user display device). Thus the billable events may be batch reported at a set interval or upon occurrence of a predetermined event, such as when the user terminates a particular tag map session.

In other embodiments, some of the advertising content initially displayed on a tag map may be embedded in the tag map and further content (or all content) is matched to be retrieved at the time of user exploration by the user within a displayed tag map. This is referred to as a “client side topic map” and may communicate back to the matching function in step 36 for further content or instructions. In other cases, the displayed tag maps include embedded content and decision making “instructions” (recommendations) depending on expected actions by a user.

In the display of the tag map in step 38, the actual display of the map is largely conventional so that the user navigates around the map as is typical of computer enabled maps. The advertising content itself may be displayed on the web page next to a tag in the form of a callout box, a rollover box, or other graphical objects on the web page clearly associated with the tag or location. This may include pop up or pop under boxes or windows; see the figures described below.

Software (virtual) instrumentation of the type well known in the field may be provided within the content matched tag map displayed in step 38. This instrumentation may provide the possibility to track user actions that satisfy criteria for particular billable events. It also may include a method to report these billable events, for instance in steps 42 and 50, back to the tag map content manager engine or associated internal or external advertising networks for accounting, quality control and payment processing by advertisers.

Thereby advantageously, advertising copy is integrated seamlessly with user created tag maps alongside other non-advertising content. This creates new possibilities for advertising with increased user action with embedded advertising copy in the tag maps or other types of computer enabled maps. This enables the advertisers to target particular users in terms of specific geographic areas, activities, locations, times or associations. This enables personalized advertising delivery based upon real time user interaction with advertising or other content.

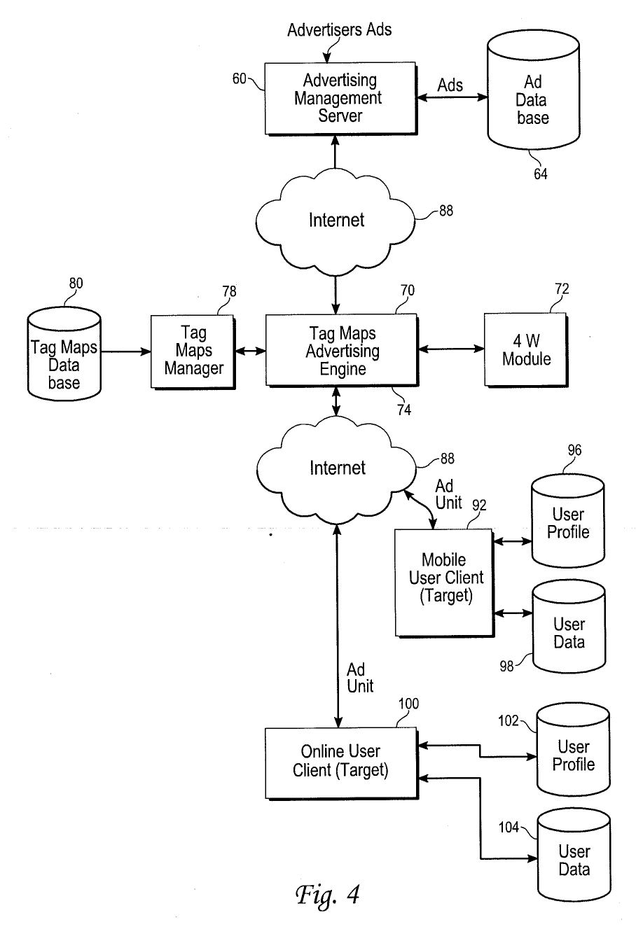

FIG. 4 shows a system to support the activities of FIG. 3, most elements of FIG. 4 are conventional. FIG. 4 thereby shows an exemplary system for carrying out the method of FIG. 3. In general, the system of FIG. 4 is in the context of a conventional Internet client-server (host) architecture, Internet servers, Internet host and clients and associated processors and storage media. The reference to server here are generally server software, but each server software module in fact is executed on a server platform, which is a type of computer. The storage elements shown in the FIG. 4 are conventional computer readable media, which is another way of referring to computer storage such as disk drives, tape drives, or semiconductor computer memory. Communication between the various elements of FIG. 4 is typically carried out by propagation of electrical (or optical) signals as conventionally in the computer field.

Starting at the top of FIG. 4, the advertising management server 60 is a computer server of conventional type which processes advertisements or advertising copy supplied in the form of digital data by an advertiser or advertisers. Server 60 is coupled to an associated advertisement database 64, which is a computer readable storage media. As shown, the advertisers or advertisers download their advertising copy (“ads”) to the advertising management server 60, which stores them in the advertisement database 64. The advertising management server is in communication via e.g., the Internet or some other type of computer network or data connection with a tag maps advertising engine 70.

Engine 70 is software and is also server based including in its platform a conventional computer processor and associated memory. Server 60 and engine 70 may be running on the same computer platform. Also provided is a tag maps database 72, which is also a computer readable storage media storing conventional tag maps as described above and which is coupled to a tag maps manager 80 (carrying out the basic tag maps functionality) which is also a software module executed on a server platform. Also coupled to the tag maps advertising engine 70 is a “4W” analysis engine 80 which is software for the “4W” analysis and which operates as described above.

The elements shown in upper half of FIG. 4 are generally under control of a system operator or operators and constitute the host or backend portion. The elements depicted below the Internet 88, to which the tag maps advertising engine is coupled, are at the client side and indicate user activity and the supporting software and computer elements. On the client side are the targets (people or “users”) who are receiving the advertising units. The first of these targets is indicated as having a mobile user client 92. Client 92 is typically running on a mobile computer platform or computer like device such as a cell phone device, personal digital assistant, etc., and is some sort of mobile computer software. Typically client 92 includes at a minimum a web browser or user browsing interface in addition to the conventional user input and output elements. Included with client 92 is a user profile 96 and user data 98, which are locally stored in the mobile computing device, but also are transmitted back up to the tag maps advertising engine 70, as needed. The user profile 96 and user data 98 are conventional in the field. They pertain to the particular user of the mobile user client 92. Another type of similar target which is essentially the same, but having a different type of platform, is online user client 100. Typically this platform would be a personal or laptop or similar computer. Again this client 102 has an associated user profile 102 and user data 104, but is otherwise the same as mobile user client 92.

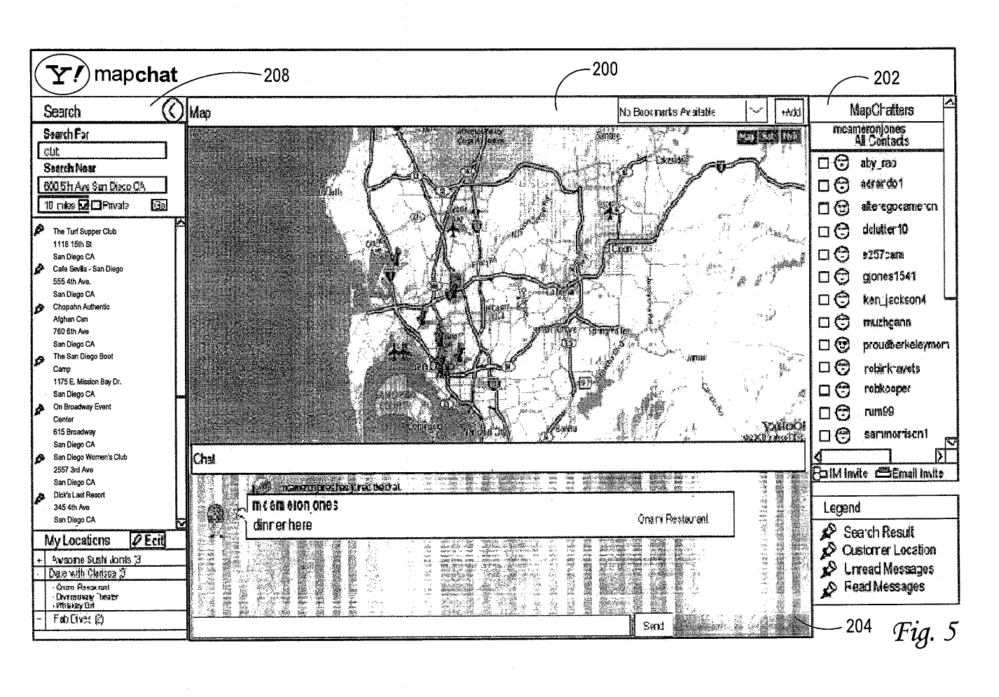

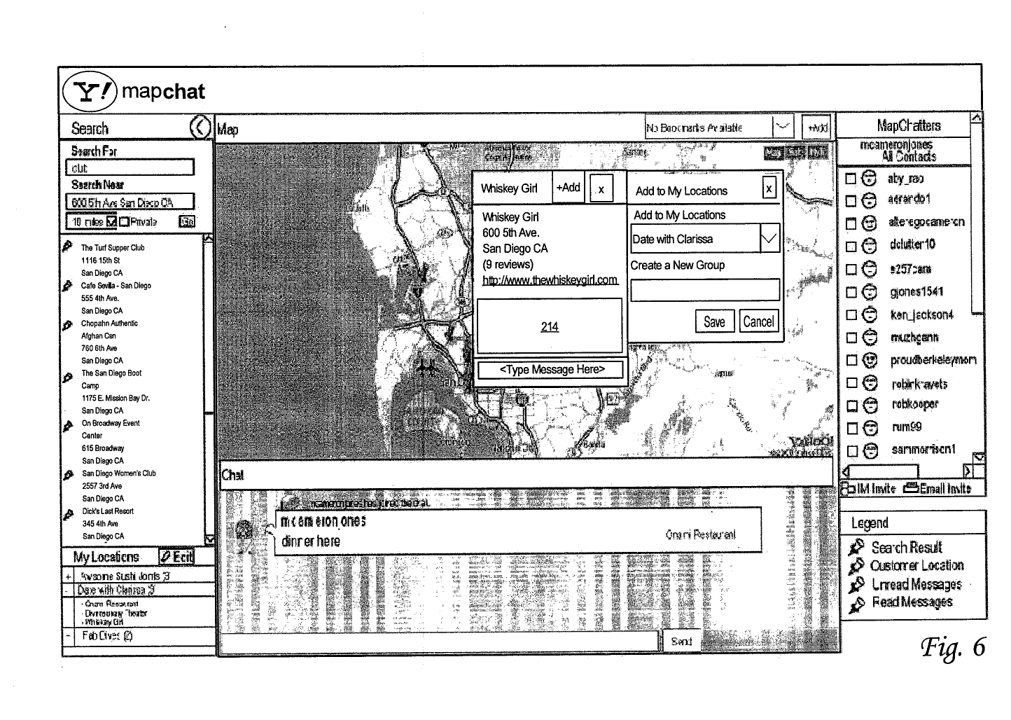

FIGS. 5 and 6 are “screenshots” as displayed to a user (target) in accordance with this disclosure. In FIG. 5 (depicting a map 200 of the San Diego, Calif. area) a “chat” between users is being held as shown at panel 202. Panel 204 shows the current user's latest comment. Since this “chat” is about a location to drink/dine, a number of suitable businesses are listed in panel 208 under the search term “club”, with a geo-locator (map) search term “600 5^{th} Ave San Diego Calif.”

FIG. 6 shows a successor screenshot with the addition of panel 214 indicating one particular establishment (“Whiskey Girl”) with further detail and a hyperlink to that business' website.

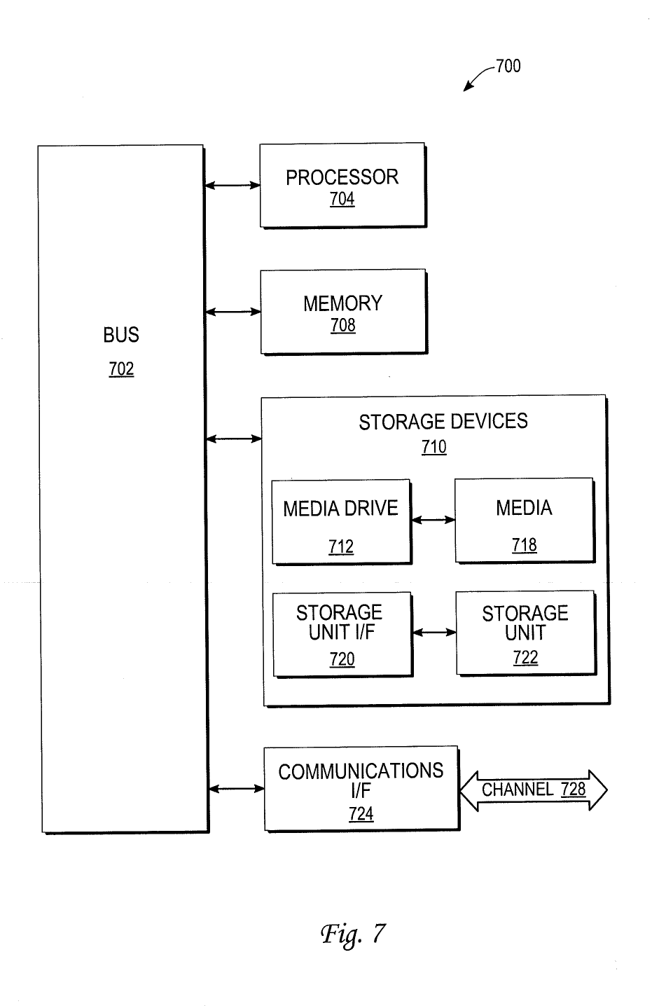

FIG. 7 illustrates a typical computing system (apparatus) 700 that may be employed to implement processing functionality in embodiments of the invention. Computing systems of this type may support any one or more of the servers or clients for example. Those skilled in the relevant art will also recognize how to implement embodiments of the invention using other computer systems or architectures. Computing system 700 may represent, for example, a desktop, laptop or notebook computer, hand-held computing device (personal digital assistant (PDA), cell phone, palmtop, etc.), mainframe, server, client, or any other type of special or general purpose computing device as may be desirable or appropriate for a given application or environment. Computing system 700 can include one or more processors, such as a processor 704. Processor 704 can be implemented using a general or special purpose processing engine such as, for example, a microprocessor, microcontroller or other control logic. In this example, processor 704 is connected to a bus 702 or other communications medium.

Computing system 700 can also include a main memory 708, such as random access memory (RAM) or other dynamic memory, for storing information and instructions to be executed by processor 704. Main memory 708 also may be used for storing temporary variables or other intermediate information during execution of instructions to be executed by processor 704. Computing system 700 may likewise include a read only memory (ROM) or other static storage device coupled to bus 702 for storing static information and instructions for processor 704.

The computing system 700 may also include information storage system 710, which may include, for example, a media drive 712 and a removable storage interface 720. The media drive 712 may include a drive or other mechanism to support fixed or removable storage media, such as a hard disk drive, a floppy disk drive, a magnetic tape drive, an optical disk drive, a compact disk (CD) or digital versatile disk (DVD) drive (R or RW), or other removable or fixed media drive. Storage media 718 may include, for example, a hard disk, floppy disk, magnetic tape, optical disk, CD or DVD, or other fixed or removable medium that is read by and written to by media drive 714. As these examples illustrate, the storage media 718 may include a computer-readable storage medium having stored therein particular computer software or data.

In alternative embodiments, information storage system 710 may include other similar components for allowing computer programs or other instructions or data to be loaded into computing system 700. Such components may include, for example, a removable storage unit 722 and an interface 720, such as a program cartridge and cartridge interface, a removable memory (for example, a flash memory or other removable memory module) and memory slot, and other removable storage units 722 and interfaces 720 that allow software and data to be transferred from the removable storage unit 718 to computing system 700.

Computing system 700 can also include a communications interface 724. Communications interface 724 can be used to allow software and data to be transferred between computing system 700 and external devices. Examples of communications interface 724 can include a modem, a network interface (such as an Ethernet or other network interface card (NIC)), a communications port (such as for example, a USB port), a PCMCIA slot and card, etc. Software and data transferred via communications interface 724 are in the form of signals which can be electronic, electromagnetic, optical or other signals capable of being received by communications interface 724. These signals are provided to communications interface 724 via a channel 728. This channel 728 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product,” “computer-readable medium” and the like may be used generally to refer to media such as, for example, memory 708, storage device 718, or storage unit 722. These and other forms of computer-readable media may store one or more instructions for use by processor 704, to cause the processor to perform specified operations. Such instructions, generally referred to as “computer program code” (which may be grouped in the form of computer programs or other groupings), when executed, enable the computing system 700 to perform functions of embodiments of the invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 700 using, for example, removable storage drive 714, drive 712 or communications interface 724. The control logic (in this example, software instructions or computer program code), when executed by the processor 704, causes the processor 704 to perform the functions of embodiments of the invention as described herein.

This disclosure is illustrative and not limiting; further modifications and embodiments will be apparent to those skilled in the art in light of this disclosure and are intended to fall within the scope of the appended claims.

1. A method implemented on a computing device of providing location related advertising, comprising the acts of:
a processor retrieving from a memory and providing at least one map;
the processor associating a plurality of displayable objects associated with a particular location on the map, the objects being advertising;
responsive to a user selecting the particular location on the map, matching one of the advertising objects to the selected location by a relevance measurement; and
transmitting the map and the matched advertising object to a display associated with the user.

2. The method of claim 1, further comprising the act of accepting from an advertiser payment for the matching.

3. The method of claim 2, wherein the payment is for a predetermined time.

4. The method of claim 1, wherein the matching occurs only after the user selects the particular location.

5. The method of claim 1, wherein the advertising objects include links, images, or audio.

6. The method of claim 1, further comprising the act of accepting from an advertiser, in advance of the matching, parameters of the relevance measurement.

7. The method of claim 1, further comprising the acts of:
providing a software application; and
using the software application to perform the matching.

8. The method of claim 1, further comprising:
responsive to the user selection providing text associated with the selected location; and
arranging the text on the map adjacent to the matched advertising object.

9. The method of claim 8, wherein if the text includes a trademark, restricting the matching to advertising objects properly associated with the trademark.

10. The method of claim 1, wherein the relevance measurement is a function of characteristics relating to the user, what the advertising object is, when the match is made, and the particular location.

11. The method of claim 1, further comprising the acts of:
providing a profile of the user; and
including the profile in the relevance measurement as the user characteristics.

12. The method of claim 11, wherein the user profile includes at least one of a context and previous website activity of the user.

13. The method of claim 8, further comprising the act of associating at least one user activity parameter with the text.

14. The method of claim 13, wherein each user activity parameter is selected from a group consisting of: impressions, mouse movements, mouse clicks, zooms, drags, location changes, interactions, annotations, and user generated content.

15. The method of claim 1, wherein the advertising object is selected from a group consisting of: a callout box, a rollover box, a graphical object, a pop up box, a pop under box, and a window.

16. A computer readable medium carrying computer code for carrying out the method of claim 1.

17. A computer server programmed to be a special purpose machine pursuant to instructions from program software to carry out the method of claim 1.

18. Computer apparatus for providing location related advertising, comprising:
a first server storing mapping data; and
a second server coupled to the first server and which associates a plurality of displayable objects associated with a particular location on a map defined by the mapping data; wherein the objects are advertising, the second server being connectable by a network to a source of the objects;
wherein the association is responsive to receipt of a user selection of the particular location on the map and includes matching one of the advertising objects by a relevance measurement; and
wherein the second server has a port for receiving the user selection and for sending the map and the matched objects to the user.

19. The apparatus of claim 18, further comprising:
a third server coupled to the second server for accepting from an advertiser payment for the matching.

20. The apparatus of claim 19, wherein the payment is for a predetermined time.

21. The apparatus of claim 18, wherein the matching occurs only after the user selects the particular location.

22. The apparatus of claim 18, wherein the advertising objects include links, images, or audio.

23. The apparatus of claim 18, wherein the second server accepts from an advertiser, in advance of the matching, parameters of the relevance measurement.

24. The apparatus of claim 18, further comprising a software application to perform the matching.

25. The apparatus of claim 18, wherein the second server, responsive to the user selection, provides text associated with the selected location and arranges the text on the map adjacent to the matched advertising object.

26. The apparatus of claim 25, wherein if the text includes a trademark, the matching is restricted to advertising objects properly associated with the trademark.

27. The apparatus of claim 18, wherein the relevance measurement is a function of characteristics of the user, what the advertising object is, when the match is made, and the particular location.

28. The apparatus of claim 18, wherein the second server obtains a profile of the user and includes the profile in the relevance measurement as the characteristics.

29. The apparatus of claim 28, wherein the user profile includes at least one of a context and previous website activity of the user.

30. The apparatus of claim 25, wherein the second server associates at least one user activity parameter with the text.

31. The apparatus of claim 30, wherein each user activity parameter is selected from a group consisting of: impressions, mouse movements, mouse clicks, zooms, drags, location changes, interactions, annotations, and user generated content.

32. The apparatus of claim 18, wherein the advertising object is selected from a group consisting of: a callout box, a rollover box, a graphical object, a pop up box, a pop under box, and a window.
